(19) United States
(12) Patent Application Publication
(10) Pub. No.: US 2007/0294359 A1
(43) Pub. Date: Dec. 20, 2007

(54) System and method of implementing remote access and control of registered personal appliances via instant messaging

(76) Inventors: Sandy Kao, Austin, TX (US); Arif Kasim, San Antonio, TX (US); Rodrigo Pastrana, Delray Beach, FL (US); Cesar E. Santiago, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/455,549

(22) Filed: Jun. 19, 2006

(51) Int. Cl. G06F 15/16

(52) U.S. Cl. 709/207

(57) ABSTRACT

A computer-implementable method, system, and computer-usable medium for implementing remote access and control of registered personal appliances via instant messaging. In a preferred embodiment of the present invention, a user registers at least one appliance as a client with an instant messaging server, logs into said instant messaging server, interacts with said at least one appliance via an instant messenger interface.

### BACKGROUND OF THE INVENTION

1. Technical Field

The present invention relates in general to the field of data processing systems. More particularly, the present invention relates in general to networking data processing systems. Still more particularly, the present invention relates to a system and method of implementing remote access and control of registered personal appliances via instant messaging.

2. Description of the Related Art

In recent times, there has been a surge of applications and home appliances with computing ability and internet connectivity. There is a need for a system and method for remotely accessing and controlling such applications and home appliances.

### SUMMARY OF THE INVENTION

The present invention includes a computer-implementable method, system, and computer-usable medium for implementing remote access and control of registered personal appliances via instant messaging. In a preferred embodiment of the present invention, a user registers at least one appliance as a client with an instant messaging server, logs into said instant messaging server, interacts with said at least one appliance via an instant messenger interface.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary network in which a preferred embodiment of the present invention may be implemented;

FIG. 2 is a block diagram depicting an exemplary data processing system in which a preferred embodiment of the present invention may be implemented;

FIG. 3 is a high-level logical flowchart diagram illustrating an exemplary method for implementing remote access and control of registered personal appliances via instant messaging;

FIG. 4 is a pictorial representation of an exemplary instant messenger interface according to a preferred embodiment of the present invention; and

### DETAILED DESCRIPTION OF A PREFERRED EMBODIMENT

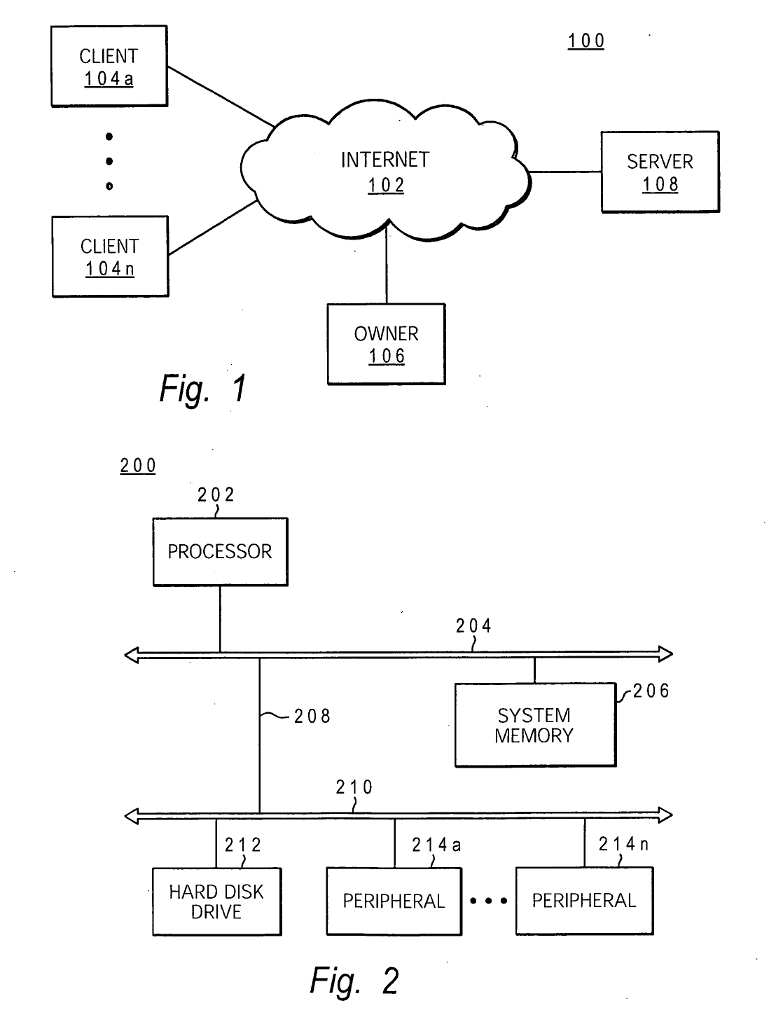

Referring to the figures, and in particular, referring now to FIG. 1, there is illustrated an exemplary network 100 in which a preferred embodiment of the present invention may be implemented. As illustrated, network 100 includes Internet 102, clients 104a-n, owner 106, and server 108. In a preferred embodiment of the present invention, Internet 102 couples clients 104a-n, owner terminal 106, and server 108. Clients 104a-n are preferably implemented as applications or appliances (e.g., refrigerator, air conditioning unit, home alarm system, etc.). Owner terminal 106 is utilized by the owner of clients 104a-n to access server 106 via Internet 102 to monitor the status and control clients 104a-n. Server 106 is preferably implemented as an instant messaging server.

FIG. 2 is an exemplary data processing system 200 utilized to implement clients 104a-n, owner terminal 106, and server 108 according to a preferred embodiment of the present invention. As depicted, data processing system 200 includes a processing unit 202 coupled to memory 206 via system interconnect 204. Those with skill in the art will appreciate that memory 206 may be implemented by a set of Dynamic Random Access Memory (DRAM) circuits or any other type of circuit utilized to implement memory systems.

Mezzanine interconnect 208 couples system interconnect 204 with peripheral interconnect 210. Those with skill in the art will appreciate that peripheral interconnect 210 may be implemented by any type of system bus including, but not limited to, a peripheral component interconnect (PCI), accelerated graphics port (AGP), or any other peripheral bus. Coupled to peripheral bus 210 is hard disk drive 212, which is utilized by data processing system 200 as a mass storage device. Also coupled to peripheral bus 210 are a collection of peripherals 214a-n.

Those skilled in the art will appreciate that data processing system 200 can include many additional components not specifically illustrated in FIG. 2. Because such additional components are not necessary for an understanding of the present invention, they are not illustrated in FIG. 2 or discussed further herein. It should also be understood, however, that the enhancements to data processing system 200 to remote access and control of registered personal appliances via instant messenger provided by the present invention are applicable to data processing systems of any system architecture and are in no way limited to the generalized single processor architecture illustrated in FIG. 2.

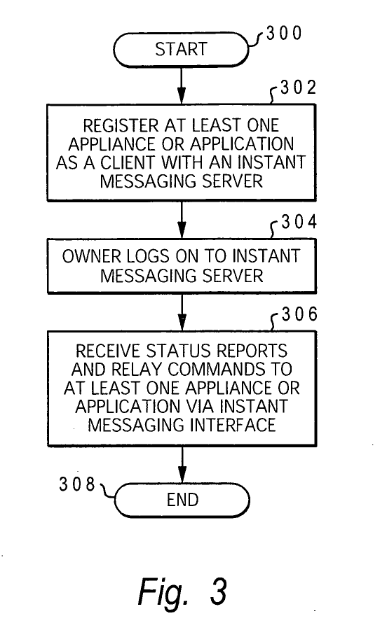

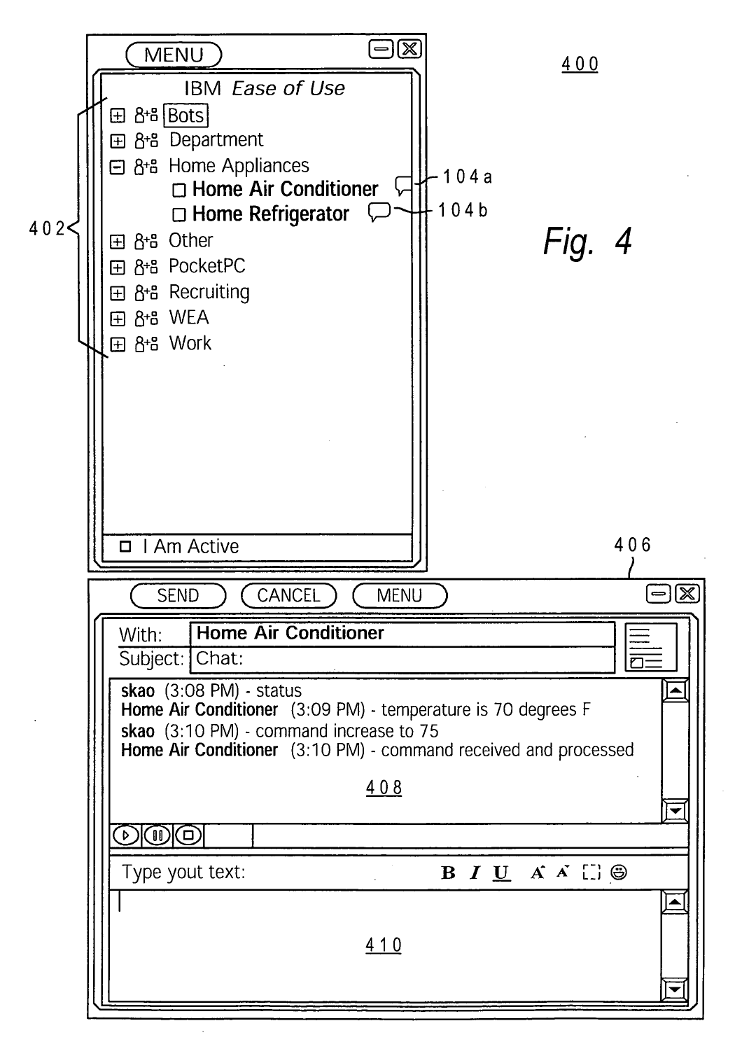

FIG. 3 is a high-level logical flowchart diagram illustrating an exemplary method for implementing remote access and control of registered personal appliances via instant messaging. The process begins at step 300 and proceeds to step 302, which illustrates a user (i.e., owner 106) registering at least one appliance or application as a client with an instant messaging server (e.g., server 108). In a preferred embodiment of the present invention, the user can specify a list of “allowed” users that may access the appliances and applications or enable a default permissions mode that blocks all other users except for the user that originally registered the appliances and applications. The process continues to step 304, which illustrates an owner 106 logging on to instant messaging server 106 via an instant messaging interface 400 depicted in FIG. 4.

The process continues to step 306, which illustrates owner 106 receiving status reports and relaying commands to at least one appliance and application via instant messaging interface 400. Instant messaging interface 400 includes a client list 402, which further includes clients 104a-b. Chat interface 406 includes chat log 408 and text entry field 410. A user (via instant messaging interface 400 stored in the memory 206 of owner 106) may receive status updates via chat log 408 and send commands to clients 102a-b via text entry field 410. Once a user decides to end the process, owner 106 logs off the system and the process ends, as illustrated in step 308.

As discussed, the present invention includes a computer-implementable method, system, and computer-usable medium for implementing remote access and control of registered personal appliances via instant messaging. In a preferred embodiment of the present invention, a user registers at least one appliance as a client with an instant messaging server, logs into said instant messaging server, interacts with said at least one appliance via an instant messenger interface.

It should be understood that at least some aspects of the present invention may alternatively be implemented in a computer-usable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDAs), telephones, and any other system capable of processing, transmitting, receiving, capturing and/or storing data.

What is claimed is:

1. A computer-implementable method comprising:
registering at least one appliance as a client with an instant messaging server;
logging into said instant messaging server; and
interacting with said at least one appliance via an instant messenger interface.

2. The computer-implementable method according to claim 1, wherein said interacting further comprises:
receiving status updates concerning said at least one appliance via said instant messenger interface.

3. The computer-implementable method according to claim 1, wherein said interacting further comprises:
sending commands to said at least one appliance to alter at least one setting of said at least one appliance via said instant messenger interface.

4. The computer-implementable method according to claim 1, further comprising:
specifying a list of allowed users that may access said at least one appliance via said instant messenger interface.

5. The computer-implementable method according to claim 1, further comprising:
specifying a default setting wherein all users are blocked from accessing said at least one appliance except for a main user that originally registered said at least one appliance.

6. A system comprising:
a processor;
a databus coupled to said processor; and
a computer-usable medium embodying computer program code, said computer-usable medium being coupled to said databus, said computer program code comprising instructions executable by said processor and configured for:
registering at least one appliance as a client with an instant messaging server;
logging into said instant messaging server; and
interacting with said at least one appliance via an instant messenger interface.

7. The system according to claim 6, wherein said instructions for interacting are further configured for:
receiving status updates concerning said at least one appliance via said instant messenger interface.

8. The system according to claim 6, wherein said instructions for interacting are further configured for:
sending commands to said at least one appliance to alter at least one setting of said at least one appliance via said instant messenger interface.

9. The system according to claim 6, wherein said instructions are further configured for:
specifying a list of allowed users that may access said at least one appliance via said instant messenger interface.

10. The system according to claim 6, wherein said instructions are further configured for:
specifying a default setting wherein all users are blocked from accessing said at least one appliance except for a main user that originally registered said at least one appliance.

11. A computer-usable medium embodying computer program code, said computer program code comprising computer-executable instructions configured for:
registering at least one appliance as a client with an instant messaging server;
logging into said instant messaging server; and
interacting with said at least one appliance via an instant messenger interface.

12. The computer-usable medium according to claim 11, wherein said embodied computer program code comprising computer-executable instructions for interacting further comprises computer-executable instructions configured for:
receiving status updates concerning said at least one appliance via said instant messenger interface.

13. The computer-usable medium according to claim 11, wherein said embodied computer program code comprising computer-executable instructions for interacting further comprises computer-executable instructions configured for:
sending commands to said at least one appliance to alter at least one setting of said at least one appliance via said instant messenger interface.

14. The computer-usable medium according to claim 11, wherein said embodied computer program code comprising computer-executable instructions configured for:
specifying a list of allowed users that may access said at least one appliance via said instant messenger interface.

15. The computer-usable medium according to claim 11, wherein said embodied computer program code comprising computer-executable instructions configured for:
specifying a default setting wherein all users are blocked from accessing said at least one appliance except for a main user that originally registered said at least one appliance.
